(19) United States
(12) Patent Application Publication
(10) Pub. No.: US 2021/0307260 A1
(43) Pub. Date: Oct. 7, 2021

(54) PLATE-SHAPED STRUCTURE, A RESERVOIR AND A METHOD

(71) Applicant: Debora DE FATIMA AURIA ARANDA, Roosendaal (NL)

(72) Inventor: Petrus Mattheus Maria HOFF, Steenbergen (NL)

(21) Appl. No.: 17/133,772

(22) Filed: Dec. 24, 2020

Related U.S. Application Data
(63) Continuation of application No. 15/545,538, filed on Jul. 21, 2017, now abandoned.

(30) Foreign Application Priority Data
Jan. 23, 2015 (NL) 2014185

(51) Int. Cl. A01G 13/02; A01G 29/00

(52) U.S. Cl. CPC A01G 13/0243; A01G 27/008; A01G 29/00

(57) ABSTRACT

The invention relates to a plate-shaped structure for cultivating one or more plants. The plate-shaped structure (1) may optionally collect moisture from the atmosphere and comprises a generally flat upper surface (30) provided with a cavity (31, 32, 33) for holding plant material. The cavity has a sidewall (41, 42, 43) and a bottom portion (51, 52, 53). Further, the bottom portion includes an aperture. In use, the plate shaped structure can cover a reservoir (10) or can be placed on the soil. Optionally, the plate-shaped structure comprises a drain opening (35) with a floating cap and a covering cap so as to allow moisture to flow through the drain opening while minimizing evaporation. Further, the plate-shaped structure may have a cap structure (84) at its periphery for clampingly receiving the upwardly extending exterior sidewall of the reservoir. The plate-shaped structure can be fixed to the reservoir using protrusions (57 a-c, 58a-c) traversing corresponding openings.

The invention relates to a plate-shaped structure for cultivating one or more plants, comprising a generally flat upper surface, especially for connecting to a reservoir.

Such a plate-shaped structure is e.g. known from WO 2012/081980. Both the plate-shaped structure and the reservoir can be made from paper material rendering the plant irrigation system very cheap. The known plate-shaped structure is provided with a central opening for surrounding a plant to be protected.

Although the plate-shaped structure and the reservoir provide satisfying results in practice, there is an ongoing need to increase its functionality.

It is an object of the invention to provide a plate-shaped structure according to the preamble wherein the functionality increases. Thereto, the generally flat upper surface is provided with a single or a multiple number of cavities for receiving plant material, the cavity having a sidewall and a bottom portion, wherein the bottom portion includes an aperture traversing the plate-shaped structure. Then, not only a single plant or two plants surrounded by a central opening of a known plate-shaped structure can be cultivated, but also further plant material may be cultivated, e.g. seed material.

According to a further aspect, the generally flat upper surface comprises a drain opening provided with a sidewall extending downwardly in a tapered manner for flowing moisture that is received on the generally flat upper surface downwardly. By further providing a floating cap located in said drain opening, the floating cap having a generally flat central portion and a downwardly corrugated edge portion having an outer contour that is in conformity with a cross sectional geometry of the downwardly tapered sidewall of the drain opening, an adequate solution is obtained for effectively flowing water into the reservoir. Then, it is also counteracted that the generally flat upper surface remains humid and collapses. By providing the above-described drain opening cooperating with the floating cap, the overall structure of the plate-shaped structure remains intact, also during wet atmospheric conditions, thus counteracting evaporation of pre-collected moisture. By providing the drain opening and the floating cap, evaporation of precious moisture is counteracted while still offering a capacity of harvesting rainwater during a heavy rain shower.

The plate-shaped structure can thus be provided such that weight and/or damage of water, sand and/or soil can be resisted.

According to yet a further aspect, the plate-shaped structure further comprises a stay defining a predefined offset between opposite sections of the central opening. By providing a stay defining a predefined offset between opposite sections of the interior side wall top edge of the reservoir, any deformation of the interior side wall inwardly into the area surrounded by said interior side wall is counteracted, thereby maintaining the shape and orientation of the interior side wall so that the connection is also maintained and the occurrence of any undesired opening in the connection is counteracted. Then, evaporation of precious moisture from the reservoir is counteracted.

In a particular embodiment, the plate-shaped structure is arranged for collecting moisture.

Further advantageous embodiments according to the invention are described in the following claims.

The invention also relates to a reservoir.

Further, the invention relates to a method.

By way of example only, embodiments of the present invention will now be described with reference to the accompanying figures in which

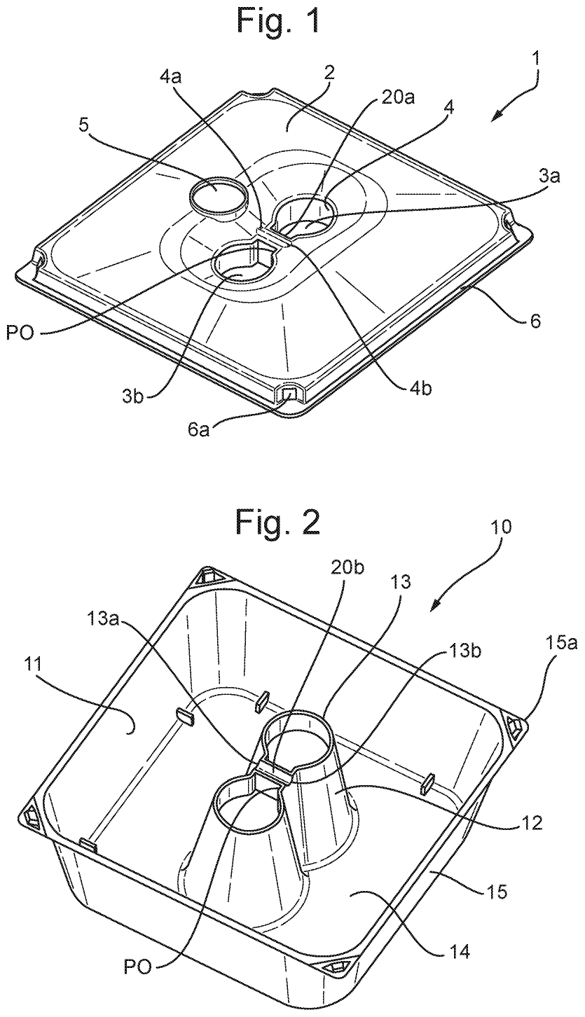

FIG. 1 shows a schematic perspective view of a plate-shaped structure for cultivating one or more plants according to the invention;

FIG. 2 shows a schematic perspective view of a reservoir according to the invention; and

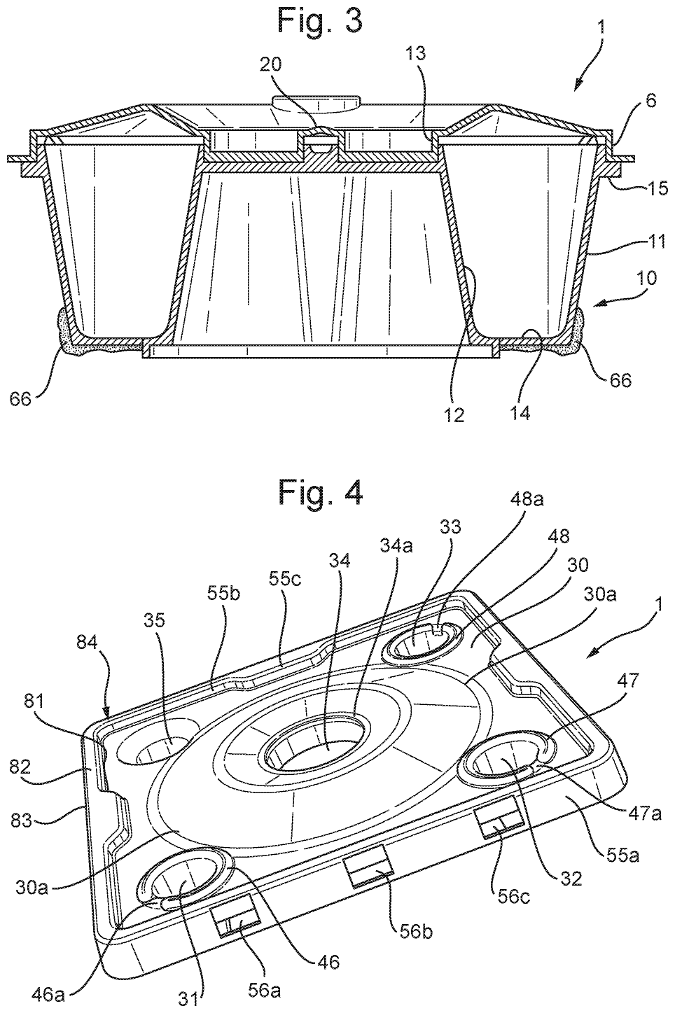

FIG. 3 shows a schematic perspective cross sectional view of the plate-shaped structure of FIG. 1 and the reservoir of FIG. 2 in assembled state;

FIG. 4 shows an upper schematic perspective view of a second embodiment of a plate-shaped structure for cultivating one or more plants according to the invention;

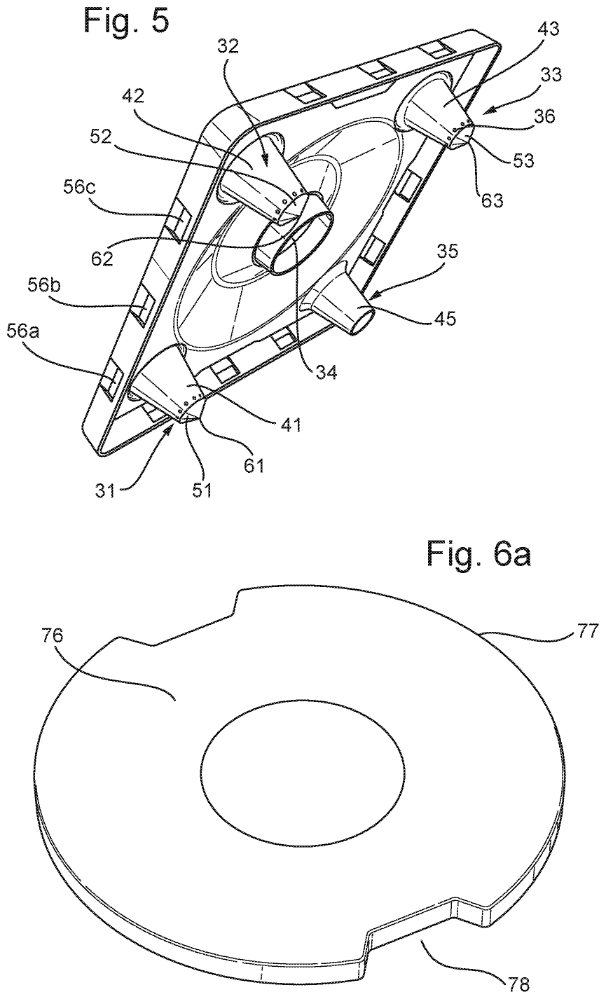

FIG. 5 shows a lower schematic perspective view of the plate-shaped structure of FIG. 4;

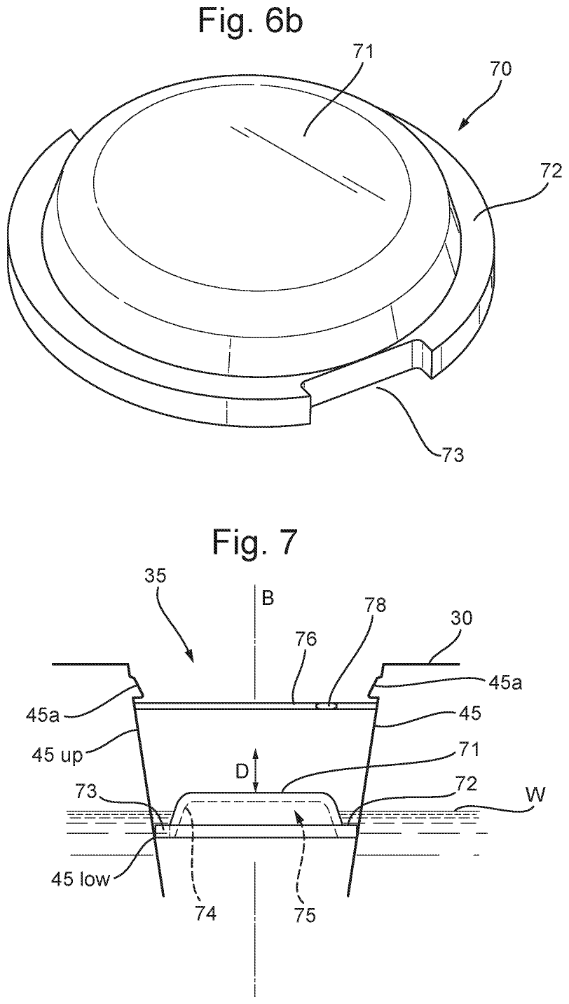

FIG. 6a shows a perspective schematic view of a covering cap positioned in an upper portion of the drain opening of the plate-shaped structure shown in FIGS. 4 and 5;

FIG. 6b shows a perspective schematic view of a floating cap positioned in the drain opening of the plate-shaped structure shown in FIGS. 4 and 5;

FIG. 7 shows a schematic cross sectional view of the drain opening of the plate-shaped structure shown in FIGS. 4 and 5;

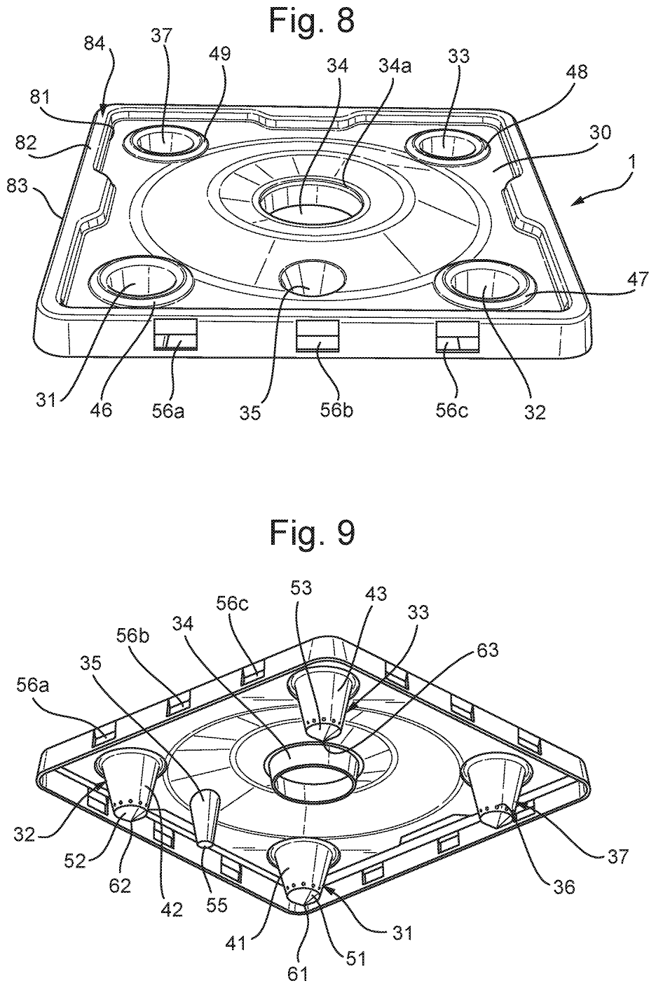

FIG. 8 shows an upper schematic perspective view of a third embodiment of a plate-shaped structure for cultivating a plant according to the invention;

FIG. 9 shows a lower schematic perspective view of the plate-shaped structure of FIG. 8;

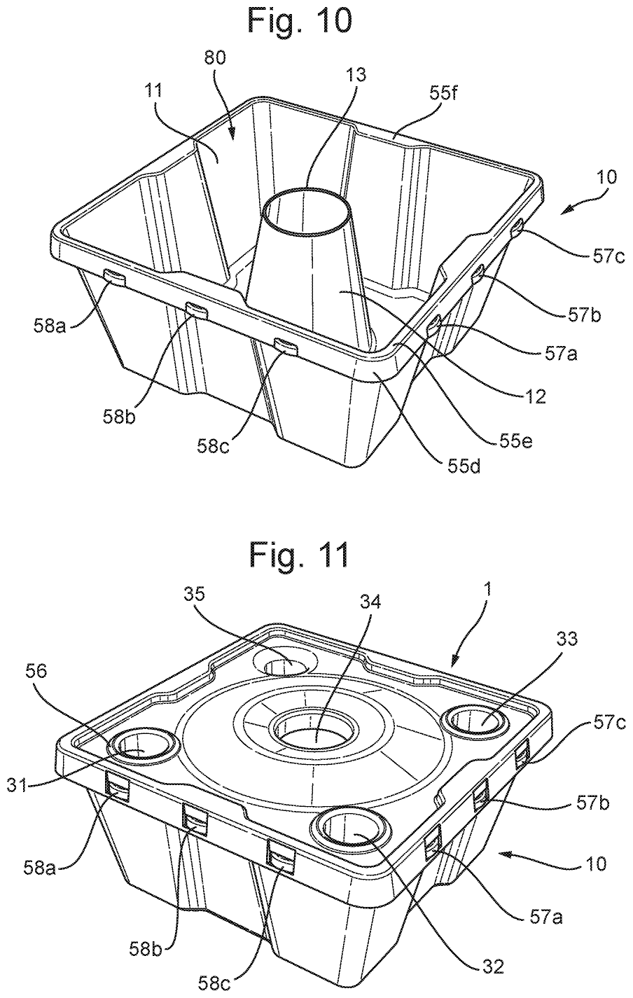

FIG. 10 shows a schematic perspective view of a second embodiment of a reservoir according to the invention;

FIG. 11 shows a perspective schematic view of the plate-shaped structure of FIG. 4 and the reservoir of FIG. 10 in an assembled state, and

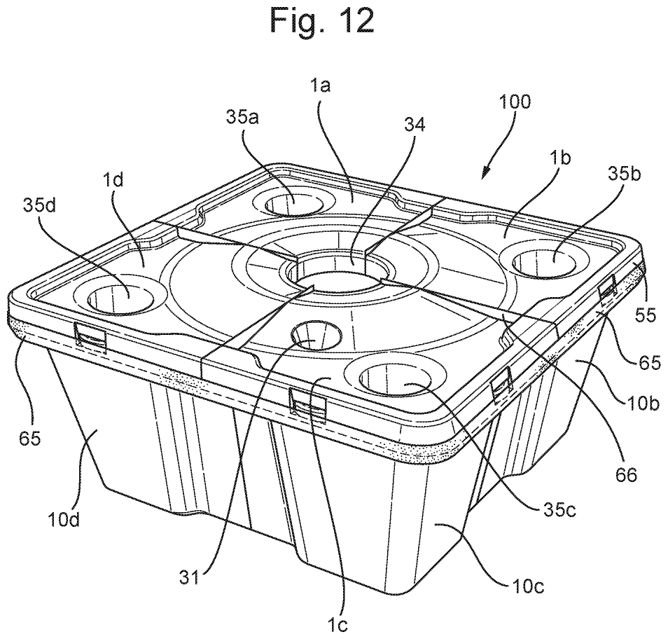

FIG. 12 shows a perspective schematic view of further plate-shaped structure and a further reservoir in an assembled state.

It is noted that the figures show merely preferred embodiments according to the invention. In the figures, the same reference numbers refer to equal or corresponding parts.

FIG. 1 shows a schematic upper perspective view of a plate-shaped structure for cultivating one or more plants according to the invention. The structure is implemented as a collection structure 1. The collection structure 1 comprises a water recovery surface 2. Further, the collection structure 1 is provided with a central opening 3a,b having a rim 4 for at least partly sideways surrounding a young plant. The collection structure 1 also includes a hole 5, for refilling a reservoir located below the collection structure 1. Further, the collection structure 1 comprises an exterior rim 6 having a profile that is corrugated in a direction mainly transverse with respect to a plane wherein the water recovery surface 2 extends. The collection structure 1 is preferably formed as a single cover module, preferably forming an airtight cover. During operation, the collection structure 1 is connected to a reservoir 10 for sealing the interior of the reservoir.

It is noted that the refilling hole 5 can be implemented as the drain opening 35 described in more detail referring to FIG. 4.

FIG. 2 shows a schematic upper perspective view of a reservoir 10 according to the invention. The reservoir 10 has an upwardly extending exterior side wall 11 having a exterior top edge 15 facing outwardly and an interior side wall 12 extending upwardly having a top edge 13 for forming a tube for at least partly sideways surrounding the young plant. The reservoir 10 has also a bottom 14 extending between the exterior and interior side wall 11, 12. Advantageously, the reservoir 10 can be provided with irrigation means for delivering moisture present in the reservoir 10 to a subsoil located there below. As an example, the irrigation means may include a single or a multiple number of capillary cords, injection needles or membranes traversing the bottom 14 or a side wall 11, 12 of the reservoir 10. The geometry of the rim 4 of the central opening 3a,b of the collection structure 1 corresponds with the geometry of the top edge 13 of the interior side wall 12 of the reservoir 10, such that when the connection structure 1 is connected to the reservoir 10, in an assembled state, the central opening rim 4 of the collection structure 1 cooperates with the top edge 13 of the interior side wall 11 of the reservoir 10, preferably in a sealing way, e.g. using a snap fitting.

According to an aspect, the collection structure 1 or the reservoir 10 or both the collection structure 1 and the reservoir 10 may comprise a stay 20 defining a predefined offset PO between opposite sections 13a,b of the top edge 13 of the interior side wall 12.

In the shown embodiment, both the collection structure 1 and the reservoir 10 include such a stay 20a,b. The stay 20a,b is here implemented as a strip integrally formed with the water recovery surface 2, forming a bridge between opposite sections. In the collection structure 1, the stay 20a interconnects opposite rim sections 4a,b for defining the predefined offset PO when the collection structure 1 is connected to the reservoir 10. Similarly, in the reservoir 10, the stay 20b interconnects opposite sections 13a,b of the interior side wall top edge 13, thus defining the predefined offset PO there between. In alternative embodiments, only the collection structure or the reservoir 10 is provided with a stay 20a,b. Further, the stay 20 may be implemented in another way, e.g. as a ridge or flange. It is noted that, in principle, the stay 20 can be integrally formed or partially integrally formed, e.g. integrally formed with a part of the collection structure. Further, the stay 20 can be formed as a single or a multiple number of discrete elements, e.g. as a separate block element mounted or clampingly positioned between opposite rim sections 4a,b or between opposite top edge sections 13a,b, respectively.

In the shown embodiment of the reservoir 10, the top edge 13 of the interior side wall 12 mainly surrounds a bar-bell shaped area, i.e. the top edge 13 has bar-bell contour. The stay 20 interconnects opposite edge sections 13a,b having the shortest mutual distance, i.e. halfway end portions of the bar-bell shaped area.

In an alternative embodiment, the top edge 13 of the interior side wall 12 mainly surrounds or encloses a disc-shaped area, a square-shaped area or an elongated area. Further, the top edge 13 of the interior side wall 12 may surround an area having an open end, such as an U-shaped area.

Preferably, the central opening rim 4 of the collection structure 1 and the top edge 13 of the interior side wall 12 of the reservoir 10 form an airtight connection, e.g. using a snap fitting, so that escape of moisture or humid air is minimized or even reduced to zero or almost zero.

In an advantageous manner, the exterior rim 6 of the collection structure 1 cooperates with the exterior top edge 15 of the reservoir 10, preferably in an airtight connection, when the collection structure 1 is connected to the reservoir 10. Then, the reservoir can be sealed from the atmosphere. Preferably, a single or a multiple number of bleeding openings can be provided in the reservoir to counteract that the process of delivering moisture to the subsoil is hindered by a sub-pressure of air in the reservoir 10.

As shown in FIG. 2, the exterior top edge 15 of the reservoir exterior side wall 11 mainly forms a square contour. Similarly, the exterior rim 6 of the collection structure 1 has a corresponding contour. In a connected state, exterior rim corner protrusions 15a of the collection structure 1 clampingly engage through corresponding corners 6a of the exterior side wall top edge 15, e.g. by firmly connecting the corresponding corners with each other, thereby stretching the collection structure between the corners of the exterior side wall top edge 15, thereby improving the air sealing behaviour of the connection between the connection structure 1 and the reservoir 10. Further, a chance is reduced that the connection structure 1 is blown away by gale or vacuum forces.

Preferably, the collection structure and the reservoir are detachably coupled, thereby providing a modular design enabling re-use of modular components. However, the collection structure and the reservoir can also be formed to provide a permanent coupling, e.g. for enhancing airtight sealing properties.

FIG. 3 shows a schematic perspective cross sectional view of a plant irrigating system including the reservoir 10 and the collection structure 1 according to the invention. In the shown embodiment, the exterior rim 6 of the collection structure 1 surrounds the top edge 15 of the exterior side wall 11 of the reservoir 10. The exterior rim 6 preferably overlaps the top edge 15 at opposite sides thereof, thereby providing a clamping connection. The top edge 15 of the reservoir's exterior side wall 11 may have a bended end portion 15a that is mainly parallel to the bottom 14 of the reservoir 10 and extends outwardly, to enhance the connection with the collection structure 1. Alternatively, the top edge 15 is flat and extends upwardly. After connecting the collection structure 1 to the reservoir 10 the material of the collection structure may shrink, especially when exposed to a sun beam, thereby further strengthening the connection between the connection structure 1 and the reservoir 10.

In a very advantageous manner, the collection structure and/or the reservoir are manufactured from cellulose and/or paper material and/or plastic such as biodegradable plastic. The paper material may include cardboard, cellulose, such as paper tissue, paper foam and/or fiber paper.

As an example, the fiber paper may include cellulose made from coconut fiber, cotton fiber, banana fiber, jute fiber, wool fiber, straw fiber, grass fiber, hemp fiber, kenaf fiber, wheat straw paper, sunflower stalks fiber, rags fiber, mulberry paper and/or kozo.

The biodegradable plastic can be based on petroleum based plastics or renewable raw materials, both including a biodegradable additive. Plastic can be based on petroleum as raw material.

As an alternative to the embodiments shown in FIGS. 4, 5, 8, 9, 11 and 12, the water recovery surface 2 can be substantially funnel-shaped. Further, the water recovery surface 2 may have a more complex structure. As an example, the water recovery surface may comprise a receiving surface which during use makes a first angle with respect to the orientation of gravity, and a collecting surface bounding a bottom edge of the receiving surface, which collecting surface during use makes a second angle with respect to the orientation of gravity, wherein the first angle is smaller than the second angle. As an example, the water recovery surface has a corrugated profile, e.g. as described in patent publication WO 2009/078721.

It is noted that the moisture flowing structure for flowing collected moisture from the water recovery surface 2 downwardly may include an inflow opening and/or an inflow pipe extending from the water recovery surface 2 downwardly into the reservoir 10.

When the collection structure 1 is connected to the reservoir 10, a plant irrigation system is formed for protecting a young plant or tree planted in the area surrounded by the interior side wall 12 of the reservoir 10.

Preferably, material forming the collection structure and the reservoir includes water impermeable material and/or is provided with a liquid impermeable coating, e.g. on the inner and/or outer side. Further, the forming material can be coated with a biodegradable layer, preferably having a pre-determined thickness so that a desired degree of degradedness can be set. Alternatively or additionally, the degradedness of the biodegradable layer can be set by including a dosed amount of conserving material. Further, the degradedness can be set by localizing specific parts at specific heights with respect to the ground level. In general, material in the collection structure can be optimized to degrade later than material in the reservoir, due to adding additives that slow down the degrading process. This way the collection structure can function during a number of years as a ground cover and help to prevent evaporation of water, to prevent growing of competitive weeds and to add nutrients to the plant over a longer period of time.

Preferably, the base material of the collection structure and/or reservoir includes specific material that is integrated in or bound to the base material e.g. using a neutral glue 66 for a specific time period and is then disseminated into the environment, due to degradable properties of the base material. Here, the word “neutral” is to be understood as having no or only a negligible influence on the germination of plant material. In the embodiments shown in FIG. 3 the reservoir 10 is provided with a neutral glue layer 66 for providing the specific material to the reservoir 10. By setting the degradedness of the base material, the degree of dissemination of the specific material can be determined. In this way, the plate-shaped structure 1 and the reservoir 10 can function as slow release carriers for plant growth stimulators and repellents against animals, funguses and/or insects. In this respect it is noted environmental parameters, such as wind, moisture etc may influence the degradedness of the base material.

As an example, the specific material may include aromatic substances, flavourings, (artifical) fertilizer or michorizae, anti-fungal material and/or at least one insecticide, e.g. nicotine for chasing away harmful animals such as termites, and/or fungi. Further, the specific material may include seeds, symbiotic bacteria, eggs, fungi and/or spores that may germinate after leaving the base material, thereby improving the biodiversity of the irrigating system. As an example, the reservoir may include a first specific material and the collection structure may include a second specific material, as it degrades later. The number of seeds, fungi and/or spores can be determined before integrating in or attached to the base material, e.g. using glue 66.

By integrating the specific material in the base material, the base material serves as an agent for the specific material that disseminates in a dosed manner. By integrating in or attaching the specific material to the base material, the base material serves as a slow release agent for the specific material that inoculates in a dosed manner.

FIG. 4 shows an upper schematic perspective view of a second embodiment of a plate-shaped structure for cultivating a plant according to the invention. FIG. 5 shows a lower schematic perspective view of the plate-shaped structure of FIG. 4. The plate-shaped structure 1 comprises a generally flat upper surface 30 provided with three cavities 31, 32, 33, each of the cavities having a sidewall 41, 42, 43 and a bottom portion 51, 52, 53. The cavities may have various shapes, such as a rounded, oval, square, rectangular or diamond shape. The bottom portion includes an aperture 61, 62, 63 traversing the plate-shaped structure 1 to enable moisture communication between the cavities 31, 32, 33 and the inner space 80 of the reservoir 10. The sidewalls 41, 42, 43 of the cavities 31, 32, 33 are tapered downwardly.

When using the plate-shaped structure, plant material such as seeds, cuttings, rooted cuttings, plug plants and/or pot plants can be provided in the cavities. By providing moisture to said plant material, it may grow in a hydroponic way. Generally, the roots may develop in the humidity and water below them in a reservoir 10. Depending on a speed of the degrading process of the reservoir 10, the roots are eventually allowed to penetrate the soil so that the plants that are planted in the cavities can establish themselves.

Further, the generally flat upper surface 30 is provided with a central opening 34 having a rim 34a for at least partly surrounding the central plant or plants.

In an alternative embodiment, the generally flat upper surface 30 does not include a central opening 34. A reservoir can then be realized without an inner wall 12. Then, a further cavity may be realized in a central portion of the generally flat upper surface 30, e.g. for optimizing an amount of plant material to grow in a hydroponic way, to be put on the reservoir 10. In such a case the generally flat upper surface 30 can not only be used in combination with a reservoir, but can alternatively be applied directly on the soil and this way the plant material can grow directly into the soil instead of in the reservoir 10.

The generally flat upper surface 30 also includes a drain opening 35 provided with a sidewall 45 extending downwardly in a tapered manner for flowing moisture that is received on the generally flat upper surface 30 downwardly, e.g. in the inner space of the reservoir. The drain opening cooperates with a floating cap as described below thereby serving an inverted siphon function, allowing fluid to flow through the drain opening while, on the other hand, minimizing any amount of evaporation of moisture stored in the reservoir. In the shown embodiment, the drain opening has a sidewall 45, no bottom portion. Generally, a bottom portion can be provided, however, such that a pre-defined flow rate of water flowing downwardly can be achieved. In principle, the generally flat upper surface can also be implemented without a drain opening, e.g. when the plate-shaped structure is placed on the soil.

The sidewalls 41, 42, 43 are preferably provided with a multiple number of perforation openings 36 forming a perforation line, so that the bottom portion 51, 52, 53 of the cavities 31, 32, 33 can be easily removed. Then, a seed, a rooted plug including plant material or a cutting can be inserted in the cavities. The plug volume seals the opening to the reservoir, thereby counteracting undesired moisture evaporation.

As shown in FIG. 4, the shown embodiment includes upwardly raised edges 46, 47, 48 counteracting that moisture received on the generally flat upper surface 30 flows into the cavities 31, 32, 33. The edges 46, 47, 48 surround the corresponding cavities. Advantageously, the edges can be interrupted, in the shown embodiments at corner facing locations 46a, 47a, 48a, to allow a certain amount of moisture to flow from the plate-shaped structure into the cavities 31, 32, 33. Alternatively, the edges 46, 47, 48 are uninterrupted, forming circular barriers enclosing the cavities 31, 32, 33 on the plate-shaped structure. An edge is wholly or partly upwardly raised. Now, said moisture entirely flows towards the drain opening 35, also called inverted siphon, to fill the reservoir 10. Advantageously, the drain opening is located at a lower portion of the generally flat upper surface to minimize any moisture remaining on the plate-shaped structure 1.

The cavities 31, 32, 33 are mainly evenly distributed in a circumferential direction on the generally flat upper surface 30. It is noted that more or less cavities can be provided, e.g. four, five or six cavities, or two cavities. Also, a single cavity can be provided. Further, another cavity distribution can be provided, e.g. a more homogeneous two-dimensional distribution on the general flat upper surface 30.

The cavities, also called cones may have a circular, square, rectangular or polygon geometry. The cones may have an opening in the bottom of approximately 1 to 2 mm diameter. The perforation openings 36 between the sidewalls 41, 42, 43 and the corresponding bottom portion 51, 52, 53 forming a perforation line may have an elongated aperture geometry commensurating with the plate-shaped structure. The cones may have two functions: they help that after producing we can stack the collection structures in a horizontal way, especially if the cavities are distributed evenly over the plate-shaped structure. If there would be only an inverted siphon on one topside and no cones on the other top sides, then the collection structures could not be stacked in a horizontal way, but they would be stacked un such a way that the stack would go aside to one direction, away from the side where the inverted siphon is located. The cones may have a second function also. They can be filled with soil, clay particles or a planting pot, e.g. that contain one or more seeds of plants or trees. The collected moisture in the box will evaporate through the bottom opening and make the bottom of the cone humid. In combination with the seed or other plant material this will lead to germination and/or growth. The seed can root through the opening and cellulose of the collection structure and find water in the reservoir. It will then colonize the box and this way lead to the development of plants that surround the plant or tree that was planted in the central opening. Instead of a seed we can also put a cutting through the opening in the cone, with the bottom of the cutting just inside or a little above the water level in the box. The humidity will stimulate the rooting of the cutting. The cones can be either closed, open or with a weak structure in the bottom—made with a needle or through adding less cellulose—so that the root can easier penetrate. The seeds or cuttings in the cones will grow to plants and eventually colonize the surrounding around the planted tree in the middle of the plate-shaped structure. The collection structure can also function as an individual item without the water reservoir. It is then made without a inverted siphon 35 and/or a central opening 34. Then, the plate-shaped structure does include cones and can be applied directly on the soil. The collected moisture will be directed into the direction of the cones. It will enter the soil through the bottom of the cones. During the rainy period the seeds will germinate—or the cuttings or other plant material will root—and their pivotal roots will penetrate the humid soil below the cones.

Optionally, the plate-shaped structure may have a network of small channels on the surface in the form of a spider web, which not only transports the moisture but also function as a ‘bonestructure’ to make the horizontal cover stronger, which has an integrated inverted siphon opening to which the channels transport the moisture, which has a topside on the outside and a topside on the inside that is higher than the channels and the opening, this way taking care that all the collected water enters in the inverted siphon opening.

Further, the plate-shaped structure may also be provided with an overflow to prevent the water to enter the middle opening and wash the roots out when the reservoir is completely filled. The central opening 34 may be implemented with various geometries, adapted for different kinds of plants and circumstances. The shape of the central opening may be circular, square, polygon, e.g. with eight corners, rectangular. In an assembled state, the plate-shaped structure 1 and the reservoir 10 are coupled, as described in more detail below. The generally flat upper surface 30 includes a downwardly oriented flange 55 at the periphery, so that the plate-shaped structure can be stored and transported with the flat upper surface 30 oriented mainly vertically, i.e. with the downwardly oriented flange 55a,b on a supporting storing and/or transporting structure. In the shown embodiment, the downwardly oriented flange 55a,b at the periphery are part of a cap structure 84 for clampingly receiving the upwardly extending exterior sidewall of the reservoir. The cap structure 84 has the shape of an inverted U-profile including a first edge portion 81 upwardly extending from the generally flat upper surface 30, a generally flat top portion 82 adjacent to the first edge 81, and a second edge portion 83 downwardly extending from the top portion 82. Here, the second edge portion 83 is part of the downwardly oriented flange 55. The generally flat top portion 82 of the cap structure 84 may have a mainly constant width. However, in a specific design, the width of the generally flat top portion may be position dependent. In the shown embodiment, said generally flat top portion has wider sections 55c at a central position along a side of the plate-shaped structure, thereby providing improved rigidity to the plate-shaped structure. Similar to the embodiment shown in FIG. 1, openings 56a-c are provided at the outer edge of the generally flat upper surface 30 for clamping the plate-shaped structure 1 to the reservoir 10. Here, said openings 56a-c are provided in the downwardly oriented flange 55.

FIG. 6a shows a perspective schematic view of a covering cap 76 positioned in an upper portion of the drain opening 35 of the plate-shaped structure shown in FIGS. 4 and 5. The covering cap 76 has a generally flat central portion and an outer contour 77 matching a cross sectional geometry and dimension at an upper portion of the downwardly tapered sidewall 45 of the drain opening 35. In the shown embodiment, the covering cap 76 is generally disc-shaped. Further, the covering cap is provided with a notch 78 at its outer contour 77 for allowing fluid to pass the covering cap 76 from the generally flat surface 30 towards a lower part of the drain opening 35. Alternatively or additionally, the covering cap 76 is provided with an opening allowing fluid to pass.

FIG. 6b shows a perspective schematic view of a floating cap 70 positioned in the drain opening 35 of the plate-shaped structure shown in FIGS. 4 and 5. The floating cap 70 has a generally flat central portion 71 and a downwardly corrugated edge portion 72 having an outer contour that is in conformity with a cross sectional geometry of the downwardly tapered sidewall 45 of the drain opening 35. In the shown embodiment, the cross sectional geometry of the drain opening sidewall 45 is circular. Then, also the outer periphery of the cap 70 is circular, thereby optimizing sealing properties.

The downwardly corrugated edge portion 72 of the cap 70 is provided with a notch 73 so that moisture may flow through the drain opening 35 into the reservoir 10. Additionally or alternatively, a single or a multiple number of openings are provided in the generally flat central portion 71 and/or in the corrugated edge portion 72 to enable moisture flow.

FIG. 7 shows a schematic cross sectional view of the drain opening 35 of the plate-shaped structure shown in FIGS. 4 and 5. The covering cap 76 is located at an upper portion 45up of the drain opening sidewall 45, adjacent to the generally flat upper surface 30. In the shown embodiment, the covering cap 76 is locked by locking members 45a extending from the drain opening sidewall 45 radially inwardly into the opening. However, the covering cap 76 can be fixed in another manner, e.g. by clamping the covering cap76 in the sidewall 45. The sealing cap 70 is located at a lower portion 451ow of the drain opening sidewall 45, but can, in principle, move upwardly and downwardly in a certain range in a direction D mainly parallel to a body axis of symmetry B of the drain opening 35. The outer contour of the floating cap 71 is designed such that it matches a cross sectional geometry and dimension of the downwardly tapered sidewall 45 of the drain opening 35, at the above-mentioned lower portion 451ow thereof, e.g. close to or at the lower end of the drain opening sidewall 45. The floating cap 70 is provided with a lower surface 74 defining a hollow space 75 there below and within the floating cap 70, filled with air, thus providing a floating capacity to the floating cap 70. It is noted that, alternatively, a closed hollow space is included in the floating cap 70, filled with medium providing the floating characteristic to the floating cap, such as polystyrene foam. As a further alternative, or in addition, the floating cap 70 may include material having a density that is smaller than water, thus providing an upwardly oriented lifting force causing the cap 70 to float.

During use, the cap 70 slides downwardly in the drain opening 35 until the periphery contacts the sidewall of the drain opening 35, at the sidewall lower portion 451ow, thereby sealing the opening and minimizing moisture evaporation. By providing a notch or opening, moisture may flow into the reservoir. When the water level W raises, the cap floats on the water, still minimizing moisture evaporation. Now, the corrugated edge portion 72 is below the water level W and the central portion 72 is above the water level W, thereby providing a stable floating position of the cap 70.

By providing the floating cap 70, the greatest area on the water is covered, keeping the greatest part of the opening area protected against evaporation. Further, by providing the covering cap 76, a shadow is shed on the floating cap 70, thereby even further reducing an evaporation process. Further the covering cap 76 provides a protection against the entrance of dirt, leaves, soil and sand particles to fall on the floating cap 70 that would hamper the floating cap 70 to float. By maintaining a floating capacity, the floating cap 70 allows moisture to enter the reservoir, e.g. during a rainy period, but on the other hand, seals the opening entirely or almost entirely during periods of drought, this way preventing loss of precious moisture in the reservoir. In addition, the covering cap 76 provides a further protection against evaporation.

It is noted that, in another embodiment, only the floating cap is applied in the drain opening, not the covering cap, e.g. in order to save assembling steps. It is also noted that the floating cap and/or the covering cap may have another design. As an example, the floating cap may be implemented as a floating ball such as a tennis ball or a ping-pong ball. When the floating cap is implemented as a floating ball, it can be used without a notch or opening, thereby further reducing evaporation, potentially to a zero level.

FIG. 8 shows an upper schematic perspective view of a third embodiment of a plate-shaped structure 1 for cultivating a plant according to the invention. FIG. 9 shows a lower schematic perspective view of the plate-shaped structure 1. Compared to the second embodiment shown in FIGS. 4 and 5, the location of the drain opening 35 has shifted, while a fourth cavity 37 has been realized at the previous location of the drain opening.

FIG. 10 shows a schematic perspective view of a second embodiment of a reservoir according to the invention. Here, the exterior sidewall 11 of the reservoir 10 comprises outwardly extending protrusions 57a-c, 58a-c for traversing corresponding openings 56a-c of the plate-shaped structure 1. Further, the exterior sidewall 11 is flanged twice outwardly, at its upper portion, forming an inverted U-shaped profile. Optionally, the reservoir 10 is provided with needle formed openings for irrigating moisture.

Preferably, the inverted U-shaped profile on the exterior sidewall 11 has a geometry that is similar to the cap structure 84 of the plate-shaped structure 1, e.g. as shown in FIG. 9. In the shown embodiment, the upwardly extending sidewall 11 of the reservoir 10 includes an outwardly extending, generally flat top surface 55e and an edge portion 55d downwardly extending from the generally flat top surface 55e. The generally flat top surface 55e has a mainly constant width, but also has wider sections 55f at a central position along a side edge of the reservoir 10, thereby providing improved rigidity to the plate-shaped structure. Then, the reservoir can be stored and transported with the flat bottom 14 oriented mainly vertically, i.e. with the downwardly oriented flange 55d on a supporting storing and/or transporting structure. The outwardly extending protrusions 57a-c, 58a-c are provided on the edge portion 55f extending downwardly. During a process of assembling the reservoir 10 to a corresponding plate-shaped structure 1, the inverted U-shaped profile on the exterior sidewall 11 of the reservoir 10 is received in the cap structure 84 of the plate-shaped structure, thereby obtaining a relatively stiff connection between the plate-shaped structure 1 and the reservoir 10, in order to survive damaging natural forces such as wind, rain and weight of soil. The exterior dimensions of the inverted U-shaped profile of the reservoir 10 are slightly smaller than the interior dimensions of the cap structure 84 of the plate-shaped structure 1 to facilitate an easy and reliable fit when assembling the plate-shaped structure to the reservoir. Further, during the process of assembling, the outwardly extending protrusions 57a-c, 58a-c are placed and oriented to traverse the corresponding openings 56a-c of the plate-shaped structure.

FIG. 11 shows a perspective schematic view of the plate-shaped structure 1 of FIG. 4 and the reservoir 10 of FIG. 10 in an assembled state, forming an autonomous unit.

The connection of the collection structure to the reservoir can be implemented using reversed U-profiles 55d,e,f as described above referring to FIG. 10. The upper side of the exterior sidewalls of the reservoir box has reversed U-profiles. The downside of the sides of the collection structure also has reversed U-profiles, but they are a little bigger, just so much that the reversed U-profiles of the sidewalls of the box fit in it. In the outer side of the reversed U-profile of the collection structure, there are openings. In the outside of the reversed U-profile of the sidewall are ribs, also called protrusions, that fit through the openings. This way the collection cover is fixed well to the reservoir, also called box, and resistant against blowing off by strong winds, preventing sand and soil entering the reservoir with the wind, preventing water from the reservoir getting evaporated, and the reversed U-profiles in combination with the ribs prevent the sides of the reservoir and the sides of the interior side wall to collapse through the forces of water, soil and humidity. The reservoir can be square, rounded or rectangle in shape.

FIG. 12 shows a perspective schematic view of an assembled structure. The assembled structure 100 includes pre-constructed parts together forming an assembled structure having a square, rectangular, diamond, oval or rounded form, when seen from above. The assembled structure 100 is a combination of a multiple number of autonomous units shown in FIG. 11 In the embodiment shown in FIG. 12, the assembled structure includes four autonomous units each having a plate-shaped structure 1a-d and a reservoir 10a-d. The individual autonomous units can be designed such that the assembled structure 100 includes a predefined number of such autonomous units, preferably using symmetry in the design of the assembled structure 100. Generally, by designing square or rectangular shaped individual autonomous units, four autonomous units can be used to form a single assembled structure 100. The assembled structure 100 preferably has a single central hole 34 bounded by an exterior sidewall section of each individual autonomous unit. In principle, each individual autonomous unit is formed by assembling a pre-constructed plate-shaped structure 1a-d to a corresponding reservoir 10a-d, as described above. Then, the individual autonomous units are combined in a single assembled structure 100 as e.g. shown in FIG. 12. The plate-shaped structures of the individual autonomous units include preferably at least one drain opening 35a-d for filling the individual reservoir, and optionally a single or a multiple number of cavities 31. At least two individual autonomous units can be mainly identical. In the shown embodiment, the four individual autonomous units form each a quadrant of the plate-shaped structure. In a first variant, the individual autonomous units have a mainly equal size and structure, each plate-shaped structure having a drain opening 35 and a pre-selected number of cavities 31. In a second variant, the individual autonomous units can be implemented differently, e.g. as two unit types, viz. a first unit type having a drain opening 35 and a single cavity and a second unit type having a drain opening 35 and two cavities. The individual autonomous units are assembled and put together preferably using a rope, strap, tie or elastic band 65 enclosing the downwardly oriented flanges 55 at the periphery of the plate-shaped structures 1a-d. Depending on the geometry and dimensions of the plate-shaped structures and corresponding reservoirs, also another number of individual autonomous units can be pre-constructed and assembled later, e.g. two autonomous units, three autonomous units, eight autonomous units or ten autonomous units. Then, relatively small molding machines may be used for the construction of relatively large assembled structures 100 including a single central hole 34, thereby meeting specific local markets.

In order to get an optimum stacking of the product the innerside and outside side walls, the cavities, also called cones, the drain opening, also called inverted siphon, and the U-profiles may have a specified angle. The integrated inverted siphon leads to less evaporation of the water inside the reservoir. With a surface of approximately 90 cm² comparing to the approximately 1,500 cm² of the 38×38 cm reservoir 10, comparing to the approximately 1,750 cm² of the 38×46 cm reservoir 10 and comparing to the approximately 2,400 cm² of the 38 and/or 57 cm diameter rounded model reservoir 10, the inverted siphon may reduce the evaporation surface to respective approximately 6%, 5% and 7 and/or 2,75%. In the inverted siphon is a floating shell with a diameter that is approximately 6 to 10 mm less than the diameter of the inverted siphon. The model of the shell is like a plate with a cone in it, and with wings that go approximately 1 to 2 cm lower than the plate and then go horizontal again. In the middle of the cap a little space may be realized in a cone that is filled with air out so that the plate floats on the water and wings of the floating cap touch the water. It also gives the possibility to sow a seed in it or put a cutting through it. The cap then floats on top of the water while the wings are floating in the water. The wings being in the water prevent the cap from being blown away by strong winds. As soon as the water level drops the cap floats deeper until it reaches a diameter of the inverted siphon that is equal to the diameter of the cap. The wings of the cap are not anymore in the water now so it could be blown away. Now the sides of the inverted siphon hold the cap in a fixed way and being approximately 4 cm deeper in the inverted siphon, the wind cannot blow it away. The cap has little spare openings that leave the moisture in when the collection structure captures it. This helps the water level rising so that the cap can float again. The up and down moving cap closes the inverted siphon for almost 100% when the reservoir is full, and closes it for almost 100% when the reservoir's waterlevel is lower, meaning, that we have a moving cap that goes up and down in a certain range from the top. This way a floating cap is provided, preventing the water from evaporating, while in the same time providing a possibility for moisture or water to enter when there is, and being fixed through intelligent wings floating in the water.

According to an aspect, the sidewall and/or the bottom of the reservoir can function as a slow release carrier for water. The permeability of the paper can be influenced through the concentration of substances that influence the permeability of paper. Generally, a higher concentration of the substances gives a lower permeability, and a lower concentration a higher permeability. The water permeability of the reservoir can also be set by selectively coating the sidewalls and the bottom with a coating layer. By selectively applying the coating layer the water permeability can locally be set. In an exemplary embodiment, a mask is used for spraying a coating material on the sidewalls and/or the bottom. Then, a part of the sidewalls and/or the bottom is coated while another part of the sidewalls and/or the bottom is not coated. In principle, the area of coated sidewall and/or bottom is highly water impermeable, while the area of uncoated sidewall and/or bottom is a direct measure for dosing the water permeability of the reservoir. As a further option, it is noted that the water permeability of the reservoir can be set by making micro-holes in the bottom and/or sidewall of the reservoir with one or more needles The diameter of the needle, and the quantity of needles, also defines the watergift through these micro-holes. The micro-holes transport the water in the first weeks. During this period de cellulose absorbs some humidity and expands. After this period, the micro-holes may be closing. However, then the cellulose has absorbed the water and starts to add it to the soil below, through capillarity of the cellulose itself. It is noted that the above-mentioned options can be used in combination, e.g. the use of micro-holes and the application of a location dependent coating layer. It is further noted that the irrigating capacity of the reservoir can also be set by a water release function through the use of one or more capillary cords. However, the adjustment of permeability and creating of micro-holes leads to the possibility of creating a reservoir that releases water without the use of a capillary cord, and with a speed of release that can be determined depending to the needs of the soil. In order for the user to be able to understand which permeability he needs, a reservoir for salted soils that has to release a high doses each day, can be made blue, a reservoir for sandy soils that has to release a lower doses can be made yellow, and a reservoir for clay soils that has to release the less water, can be made green.

The cellulose may degrade while using. For this reason it can function as a carrier for nutrients for the plants, as a carrier for substances that combat funguses, diseases and/or damaging animals. These substances can be mixed through the cellulose during the production process. As the circumstances are very dry, commonly used fertilizers and their applying method, cannot be used because of causing too high salt concentrations around the root system, leading to burning of the roots. The slow degradation of the cellulose, in combination with macro-elements N—P—K—Mg and micro-elements may lead to protection of the roots, to non-burning of the roots and a good and sufficient mineral availability absorbing situation even under dry circumstances.

For plants mycorrhizae form the carrier of minerals in the soil, to exchange them with. In order to have a higher mycorrhizae population it is interesting to inoculate the soil with desired species. During a process of producing the reservoir and/or the plate-shaped structure, the product may be heated after a moulding process, in order to dry it. For this reason it might be undesired or impossible to mix mycorrhizae through the cellulose during the production process. The drying process may sterilize the humid cellulose. For this reason the mycorrhizae may be added to the reservoir after the production process. This can be done by putting glue to the outside of the bottom and/or side of the reservoir and attach the mycorrhizae to this glue. Other glues from a chemical background may influence the life time of mycorrhizae. Some kill the mycorrhizae, other have an influence on the germination of seeds and the root development. Glue can be neutral to root development and seed germination.

The invention is not restricted to the embodiments described herein. It will be understood that many variants are possible.

It is noted that the top edge of the reservoir exterior side wall may mainly form a square contour. However, also other contours are possible, such as a rectangular contour or a polygon contour.

Further, instead of a single stay, a multiple number of stays can be used to define a predefined offset between opposite sections of the interior side wall top edge of the reservoir.

It is also noted that the central opening of the plate-shaped structure may support a sheath foil surrounding the plant. An exemplary sheath foil is described in the Dutch patent application 2012651 in the name of the applicant.

It is noted that the design of the drain opening and the floating cap can be applied in combination with the plate-shaped structure as defined in claim 1, but also more generally in a plate-shaped structure for cultivating a plant, comprising an upper surface without a cavity. As an example, a plate-shaped structure for cultivating one or more plants can be provided with the above-mentioned drain opening and a floating cap, but without a cavity.

It is further noted that the design of the protrusions and the corresponding openings for assembling a reservoir and a plate-shaped structure for cultivating a plant according to claim 1 can be applied more generally to a reservoir and a plate-shaped structure for cultivating a plant, the structure comprising a generally flat upper surface without a cavity.

Similarly, it is noted that the concept of providing a stay on the collection structure and/or the reservoir defining a predefined offset between opposite sections of the central opening can be applied to the plate-shaped structure as defined in claim 1, but also more generally in a plate-shaped structure for cultivating a plant, comprising an upper surface without a cavity.

It also noted that the described concepts, such as the drain opening and the floating cap, the protrusions and the corresponding openings for assembling, the stay, the concept of assembling the plate-shaped structure and/or the reservoir from pre-constructed parts, the concept wherein a sidewall and/or a bottom of the reservoir functions as a slow release carrier for water, and the design of the cavity on the plate-shaped structure may be applied to plate-shaped structures or a reservoir respectively for cultivating a plant, but also to structures having another upper surface for cultivating a plant, e.g. a curved surface or a funnel-shaped surface, as described e.g. in patent publication WO 2009/078721.

As a further example of a variant, it is noted that the reservoir and/or the plate-shaped structure can be provided with stiffening elements such as horizontal, vertical and/or diagonal rim members to increase stiffness of the reservoir.

Other such variants will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A plate-shaped structure for cultivating one or more plants,
comprising a central opening having a rim for at least partly surrounding a plant or tree, the plate-shaped structure covering a reservoir for storing moisture for moistening the plant or tree, wherein the reservoir comprises an upwardly extending exterior sidewall facing outwardly and an upwardly extending interior sidewall for forming a tube for at least partly surrounding the plant or tree, and a bottom extending between the exterior and interior sidewall, the interior sidewall having a top edge cooperating with a central opening rim of the plate-shaped structure, and the exterior sidewall of the reservoir having a top edge cooperating with an exterior rim of the plate-shaped structure for sealing the interior of the reservoir during operation, wherein
a) the generally flat upper surface is provided with one or more cavities for receiving plant material to grow in a hydroponic way,
b) the one or more cavities having a sidewall and a bottom portion, wherein the bottom portion includes an aperture traversing the plate-shaped structure
c) the generally flat upper surface includes an upwardly raised edge enclosing the one or more cavities, and
d) the sidewalls of the cavities are tapered downwardly.

2. (canceled)

3. The plate-shaped structure according to claim 1, wherein the sidewall is provided with a multiple number of perforation openings forming a perforation line.

4. (canceled)

5. The plate-shaped structure according to claim 1, wherein the generally flat upper surface is provided with a multiple number of cavities for receiving plant material and wherein at least a portion of the multiple number of cavities are mainly evenly distributed in a circumferential direction

6-9. (canceled)

10. The plate-shaped structure according to claim 1, wherein the generally flat upper surface comprises a drain opening located at a lower portion of the generally flat upper surface provided with a sidewall extending downwardly in a tapered manner for entering moisture that is received on the generally flat upper surface downwardly.

11. The plate-shaped structure according to claim 10, further comprising a floating cap located in the drain opening, the floating cap having a generally flat central portion and a downwardly corrugated edge portion having an outer contour that is in conformity with a cross sectional geometry of the downwardly tapered sidewall of the drain opening.

12. The plate-shaped structure according to claim 10,
further comprising a covering cap having an outer contour matching a cross sectional geometry at an upper portion of the downwardly tapered sidewall of the drain opening, the covering cap being located at said upper portion of the drain opening.

13. The plate-shaped structure according to claim 11, wherein the downwardly corrugated edge portion of the floating cap is provided with an opening or a notch.

14. The plate-shaped structure according to claim 10, further comprising a floating cap located in the drain opening, the floating cap being implemented as a floating ball.

15. (canceled)

16. The plate-shaped structure according to claim 1, wherein the generally flat upper surface includes a downwardly oriented flange at the periphery for clampingly receiving the upwardly extending exterior sidewall of the reservoir, the downwardly oriented flange being optionally provided with openings for being traversed by outwardly extending protrusions of the reservoir.

17. (canceled)

18. The plate-shaped structure according to claim 1, wherein the plate shaped structure forms a collection structure for collecting moisture present in the atmosphere.

19. The plate-shaped structure according to claim 1, wherein the collection structure and/or the reservoir comprises a stay defining a predefined offset between opposite sections of the interior sidewall top edge.

20-21. (canceled)

22. The plate-shaped structure according to claim 1, wherein the structure and the reservoir are manufactured from cellulose, paper material and/or biodegradable plastic.

23. The plate-shaped structure according to claim 1, wherein the plate-shaped structure is connected to the reservoir forming an autonomous unit arranged in an assembled structure comprising a multiple number of autonomous units such that a central hole is formed bounded by an exterior sidewall section of each of the autonomous units.

24-25. (canceled)

26. The plate-shaped structure according to claim 1, wherein the exterior sidewall of the reservoir comprises outwardly extending protrusions traversing corresponding openings of the plate-shaped structure.

27. The plate-shaped structure according to claim 1, wherein the exterior sidewall is flanged twice outwardly, at its upper portion, forming a mainly U-shaped profile.

28. The plate-shaped structure according to claim 1 wherein the reservoir is provided with needle formed openings for irrigating moisture.

29. (canceled)

30. The plate-shaped structure according to claim 1 wherein a sidewall and/or a bottom of the reservoir functions as a slow release carrier for water.

31. A method for cultivating plant material comprising the step of providing the plate-shaped structure according to claim 1, and a step of putting a plug with plant material in the one or more cavities of the generally flat upper surface.

32-33. (canceled)

34. The plate-shaped structure according to claim 1, wherein the reservoir is made of cellulose or paper material and the sidewall and/or the bottom of the reservoir functions as a slow release carrier for water by influencing the water permeability of the paper through the concentration of substances that influence the permeability of the paper and/or wherein water permeability of the reservoir is set by making microholes in the bottom and/or sidewall of the reservoir with one or more needles.

35. The plate-shaped structure according to claim 34, wherein the reservoir functions as a slow release carrier for water by influencing the water permeability of the paper through the concentration of substances that influence the permeability of the paper by selectively coating the sidewalls and the bottom with a coating layer to locally set the water permeability.

36. The plate-shaped structure according to claim 35, wherein the permeability of the paper is set by selectively coating the sidewalls and the bottom with a coating layer using a mask.

37. The plate-shaped structure according to claim 34, wherein the reservoir releases water without the use of a capillary cord.

38. A reservoir for storing moisture for moistening one or more plants, comprising an upwardly extending exterior sidewall facing outwardly, an upwardly extending interior sidewall for forming a tube for at least partly surrounding the plant and a bottom extending between the exterior and interior sidewall, wherein the reservoir is made of cellulose or paper material and the sidewall and/or the bottom of the reservoir functions as a slow release carrier for water by influencing the water permeability of the paper through the concentration of substances that influence the permeability of the paper and/or wherein water permeability of the reservoir is set by making microholes in the bottom and/or sidewall of the reservoir with one or more needles.

39. The reservoir according to claim 38, wherein the reservoir functions as a slow release carrier for water by influencing the water permeability of the paper through the concentration of substances that influence the permeability of the paper by selectively coating the sidewalls and the bottom with a coating layer to locally set the water permeability.

40. The reservoir according to claim 39, wherein the permeability of the paper is set by selectively coating the sidewalls and the bottom with a coating layer using a mask.

41. The reservoir according to claim 38, wherein the reservoir releases water without the use of a capillary cord.
